(19) United States
(12) Patent Application Publication
(10) Pub. No.: US 2025/0070670 A1
(43) Pub. Date: Feb. 27, 2025

(54) POWER SUPPLY CONTROL DEVICE AND POWER SUPPLY DEVICE

(71) Applicant: ROHM CO., LTD., Kyoto (JP)

(72) Inventor: Kenichi OKAJIMA, Kyoto (JP)

(21) Appl. No.: 18/812,745

(22) Filed: Aug. 22, 2024

(30) Foreign Application Priority Data
Aug. 25, 2023 (JP) 2023-137328

(51) Int. Cl. H02M 3/158; H02H 3/20; H02M 1/36

(52) U.S. Cl. CPC H02M 3/158; H02H 3/20; H02M 1/36

(57) ABSTRACT

A power supply control device includes a feedback terminal, a feedback control circuit, and a terminal inspection circuit. The feedback control circuit is configured to control an output stage of a power supply device according to a feedback voltage applied to the feedback terminal. The terminal inspection circuit is configured to forcibly stop driving the output stage when it is detected that the feedback voltage is lower than a first threshold and an output current flowing through the output stage is higher than a second threshold during a first period at start-up, or when it is detected that the feedback voltage is lower than the first threshold at completion of the first period.

### CROSS-REFERENCE TO RELATED APPLICATIONS

This application is based on the following Japanese application, the contents of which are incorporated herein by reference.
(1) Japanese Patent Application No. 2023-137328 (filing date: Aug. 25, 2023)

### BACKGROUND OF THE INVENTION

### 1. Technical Field

This disclosure relates to a power supply control device and a power supply device.

### 2. Description of Related Art

Conventionally, power supply devices that generate a desired output voltage from an input voltage have been used as a power supply means for various applications.

Note that Patent Document 1 (Japanese Patent Application Publication No. 2019-213317) can be cited as an example of the related art.

### BRIEF DESCRIPTION OF THE DRAWINGS

FIG. 1 is a diagram showing a comparative example of a power supply device.

FIG. 2 is a diagram showing a start-up waveform when a feedback terminal of the comparative example is normal.

FIG. 3 is a diagram showing a start-up waveform when the feedback terminal of the comparative example is abnormal (lower resistor open or upper resistor short).

FIG. 4 is a diagram showing a start-up waveform when the feedback terminal of the comparative example is abnormal (upper resistor open or lower resistor short).

FIG. 5 is a diagram showing a start-up waveform when the feedback terminal of the comparative example is abnormal (upper and lower resistor open).

FIG. 6 is a diagram showing a first embodiment of a power supply device.

FIG. 7 is a diagram showing a start-up waveform when the feedback terminal of the first embodiment is abnormal (upper resistor open or lower resistor short).

FIG. 8 is a diagram showing a second embodiment of a power supply device.

FIG. 9 is a diagram showing a start-up waveform when the feedback terminal of the second embodiment is abnormal (upper and lower resistor open).

FIG. 10 is a diagram showing a start-up waveform when the feedback terminal of the second embodiment is normal.

FIG. 11 is a diagram showing a third embodiment of a power supply device.

FIG. 12 is a diagram showing the start-up waveform when the feedback terminal of the third embodiment is normal.

FIG. 13 is a diagram showing a fourth embodiment of the power supply device.

### DETAILED DESCRIPTION

### Power Supply Device (Comparative Example)

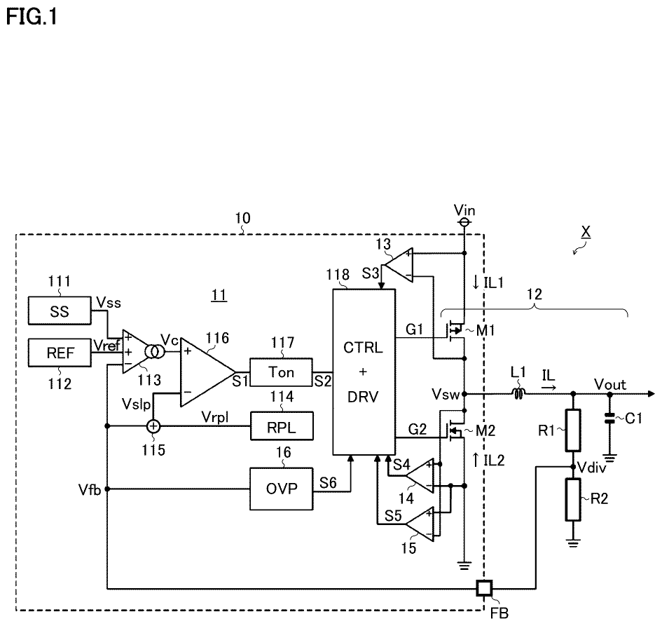

FIG. 1 is a diagram showing a comparative example of a power supply device (a configuration to be compared with the embodiment described later). The power supply device X of this comparative example is a step-down switching power supply (so-called DC/DC converter) that steps down an input voltage Vin to generate a desired output voltage Vout. In accordance with this figure, the power supply device X includes a power supply control device 10 and various discrete components (capacitor C1, inductor L1, and resistors R1 and R2) that are externally attached thereto.

The power supply control device 10 is a semiconductor integrated circuit device (so-called power supply control integrated circuit (IC)) that centrally controls the operation of the power supply device X. The power supply control device 10 includes a plurality of external terminals (only the feedback terminal FB is shown in this figure) as a means for establishing an electrical connection with the outside of the device.

Next, the external connections of the power supply control device 10 will be described. The first end of the inductor L1 is connected to a terminal to which a switch voltage Vsw is applied. The second end of the inductor L1 and the first ends of the resistor R1 and the capacitor C1 are all connected to a terminal to which the output voltage Vout is applied. The second end of the resistor R1 and the first end of the resistor R2 are all connected to the feedback terminal FB. The second ends of the capacitors C1 and R2 are all connected to the ground terminal.

The inductor L1 and the capacitor C1 function as an LC filter that rectifies and smoothes the square wave-shaped switch voltage Vsw (described in detail later) to generate the output voltage Vout.

The resistors R1 and R2 function as a resistive voltage divider circuit that generates a divided voltage Vdiv (=Vout×R2/(R1+R2)) according to the output voltage Vout and outputs the divided voltage to the feedback terminal FB. Although not shown in the figure, a speed-up capacitor may be connected in parallel across the resistor R1 so that the power supply device X starts up smoothly.

### Power Supply Control Device (Comparative Example)

Next, with reference to FIG. 1, the internal configuration and operation of the power supply control device 10 will be described in detail. In the power supply control device 10 of this comparative example, a feedback control circuit 11, an output stage 12 (more precisely, an output transistor M1 and a synchronous rectification transistor M2 forming the output stage 12), a first overcurrent protection circuit 13, a second overcurrent protection circuit 14, a zero-cross detection circuit 15, and an overvoltage protection circuit 16 are integrated.

The feedback control circuit 11 controls the output stage 12 according to a feedback voltage Vfb applied to the feedback terminal FB. In accordance with this diagram, the feedback control circuit 11 includes a soft-start voltage generation circuit 111, a reference voltage generation circuit 112, an error amplifier 113, a ripple voltage generation circuit 114, an adder circuit 115, a comparator 116, an on-time setting circuit 117, and a control drive circuit 118.

The soft-start voltage generation circuit 111 generates a soft-start voltage Vss that rises gently at a predetermined slope when the power supply control device 10 starts up.

The reference voltage generation circuit 112 generates a predetermined reference voltage Vref (corresponding to a voltage signal for setting a target value for the output voltage Vout).

The error amplifier 113 generates an error voltage Vc corresponding to the difference between the lower voltage of the soft-start voltage Vss and the reference voltage Vref input to two non-inverting input terminals (+) and the feedback voltage Vfb input to the inverting input terminal (−). The error voltage Vc rises when the feedback voltage Vfb is lower than the lower voltage of the soft-start voltage Vss and the reference voltage Vref. The error voltage Vc falls when the feedback voltage Vfb is higher than the lower voltage of the soft-start voltage Vss and the reference voltage Vref.

The ripple voltage generation circuit 114 generates a ripple voltage Vrpl that simulates the ripple component of the output voltage Vout.

The adder circuit 115 adds the ripple voltage Vrpl to the feedback voltage Vfb to generate a slope voltage Vslp.

The comparator 116 compares the slope voltage Vslp input to the inverting input terminal (−) with the error voltage Vc input to the non-inverting input terminal (+) to generate a comparison signal S1. The comparison signal S1 becomes high when the slope voltage Vslp is lower than the error voltage Vc. Moreover, the comparison signal S1 becomes low when the slope voltage Vslp is higher than the error voltage Vc. The comparator 116 may be provided with hysteresis characteristics.

The on-time setting circuit 117 generates a switch control signal S2 so that the output transistor M1 is maintained in the ON state for the on-time Ton after the comparison signal S1 rises to a high level.

As basic output feedback control, the control drive circuit 118 generates gate drive signals G1 and G2 by a bottom-detection-type on-time fixed method according to the switch control signal S0 so that the output voltage Vout matches a desired target value. The gate drive signals G1 and G2 become low when the switch control signal S2 is high, and become high when the switch control signal S2 is low, for example

The control drive circuit 118 has a function of limiting the output current IL (current flowing through the inductor L1) flowing through the output stage 12 according to an upper overcurrent protection signal S3 and a lower overcurrent protection signal S4.

The control drive circuit 118 also has a function of stopping the switching drive of the output stage 12 at light load according to a zero-cross detection signal S5. For example, the control drive circuit 118 may turn off the synchronous rectification transistor M2 when the zero-cross detection signal S5 rises to a high level while the output transistor M1 is in an OFF state and the synchronous rectification transistor M2 is in an ON state, that is, when it is detected that the switch voltage Vsw has become higher than a zero-cross detection value (for example, GND).

The control drive circuit 118 also has a function of forcibly stopping the switching drive of the output stage 12 according to an overvoltage protection signal S6.

The output stage 12 is controlled by the power supply control device 10 to generate the output voltage Vout from the input voltage Vin. The output stage 12 may be of a switching type including an output transistor M1 (for example, a P-channel type metal oxide semiconductor field effect transistor (PMOSFET)) and a synchronous rectification transistor M2 (for example, an N-channel type MOSFET (NMOSFET)) in addition to the inductor L1 and capacitor C1 described above.

The output transistor M1 functions as an upper switch element of the output stage 12. The source of the output transistor M1 is connected to the terminal to which the input voltage Vin is applied. The drain of the output transistor M1 is connected to the terminal to which the switch voltage Vsw is applied. The gate of the output transistor M1 is connected to the terminal to which the gate drive signal G1 is applied. The output transistor M1 is in an ON state when the gate drive signal G1 is at a low level. On the other hand, the output transistor M1 is in an OFF state when the gate drive signal G1 is at a high level.

The synchronous rectification transistor M2 functions as a lower switch element of the output stage 12. The drain of the synchronous rectification transistor M2 is connected to the terminal to which the switch voltage Vsw is applied. The source of the synchronous rectification transistor M2 is connected to a reference potential terminal (for example, a ground terminal to which the ground voltage GND is applied). The gate of the synchronous rectification transistor M2 is connected to the terminal to which the gate drive signal G2 is applied. The synchronous rectification transistor M2 is in an ON state when the gate drive signal G2 is at a high level. On the other hand, the synchronous rectification transistor M2 is in an OFF state when the gate drive signal G2 is at a low level.

In this way, the output transistor M1 and the synchronous rectification transistor M2 are connected in a half-bridge type and are complementarily turned on/off according to the gate drive signals G1 and G2. By such switching control, the output stage 12 generates a square wave-shaped switch voltage Vsw that is pulse-driven between the input voltage Vin and the ground voltage GND.

The term “complementary” in this specification is used to include the case where the on/OFF states of the output transistor M1 and the synchronous rectification transistor M2 are completely reversed, as well as the case where a delay is given to the on/off transition timing of each transistor (the case where a simultaneous off period is provided).

In addition, as the rectification element, instead of the synchronous rectification transistor M2, a rectification diode (for example, a Schottky barrier diode) whose cathode is connected to the terminal to which the switch voltage Vsw is applied and whose anode is connected to the ground terminal may be used. In other words, the rectification method of the output stage 12 is not limited to the synchronous rectification method, but may be a diode rectification method.

The output transistor M1 and the synchronous rectification transistor M2 may be externally attached to the power supply control device 10. If the output stage 12 needs to have a high withstand voltage, high-voltage elements such as an insulated gate bipolar transistor (IGBT), a SiC device, or a GaN device may be used as the output transistor M1 and the synchronous rectification transistor M2.

The upper overcurrent protection circuit 13 generates an upper overcurrent protection signal S3 so as to limit an upper output current IL1 flowing through the output transistor M1 in the ON state to a predetermined overcurrent protection threshold Iocp or less. The upper overcurrent protection circuit 13 may include a comparator that generates the upper overcurrent protection signal S3 by comparing the drain-source voltage of the output transistor M1 with a predetermined input offset voltage.

The lower overcurrent protection circuit 14 generates a lower overcurrent protection signal S4 so as to limit a lower output current IL2 flowing through the synchronous rectification transistor M2 in the ON state to a predetermined overcurrent protection threshold Iocp or less. The lower overcurrent protection circuit 14 may include a comparator that generates the lower overcurrent protection signal S4 by comparing the drain-source voltage of the synchronous rectification transistor M2 with a predetermined input offset voltage.

The zero-cross detection circuit 15 detects a zero-cross (reverse flow) of the lower output current IL2 flowing through the synchronous rectification transistor M2 when the output transistor M1 is in an OFF state and the synchronous rectification transistor M2 is in an ON state, and generates a zero-cross detection signal S5. For example, the zero-cross detection circuit 15 may include a comparator that generates the zero-cross detection signal S5 by detecting whether the drain-source voltage (corresponding to the switch voltage Vsw) of the synchronous rectification transistor M2 is positive or negative.

The overvoltage protection circuit 16 generates an overvoltage protection signal S6 to forcibly stop the switching drive of the output stage 12 when the feedback voltage Vfb exceeds a predetermined overvoltage protection threshold Vovp. The overvoltage protection threshold Vovp is preferably set to a voltage value higher than the reference voltage Vref.

The feedback control circuit 11 of this configuration example controls the output stage 12 so that the feedback voltage Vfb matches the lower voltage of the soft-start voltage Vss and the reference voltage Vref. Therefore, when the resistors R1 and R2 are correctly connected externally to the feedback terminal FB, Vout=Vref×(R1+R2)/R2 is established. That is, the output voltage Vout can be arbitrarily adjusted according to the resistance ratio of the resistors R1 and R2 (corresponding to the voltage division ratio of the resistive voltage divider circuit).

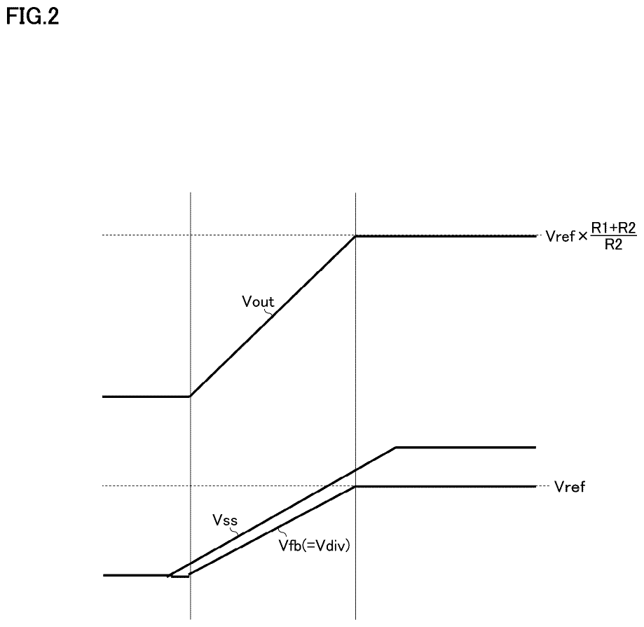

FIG. 2 is a diagram showing the start-up waveform when the feedback terminal FB of the comparative example is normal, that is, when the resistors R1 and R2 are correctly connected externally to the feedback terminal FB. The upper part of this figure shows the behavior of the output voltage Vout. The lower part of this figure shows the behavior of the soft-start voltage Vss and the feedback voltage Vfb.

As shown in this figure, when the feedback terminal FB is normal, Vdiv=Vfb. Note that while Vss<Vref, the feedback voltage Vfb rises gradually following the soft-start voltage Vss. Therefore, the output voltage Vout also rises gradually. After that, when Vss>Vref, feedback control is applied so that the feedback voltage Vfb matches the reference voltage Vref. Therefore, the output voltage Vout is maintained at the desired target value (=Vref×(R1+R2)/R2).

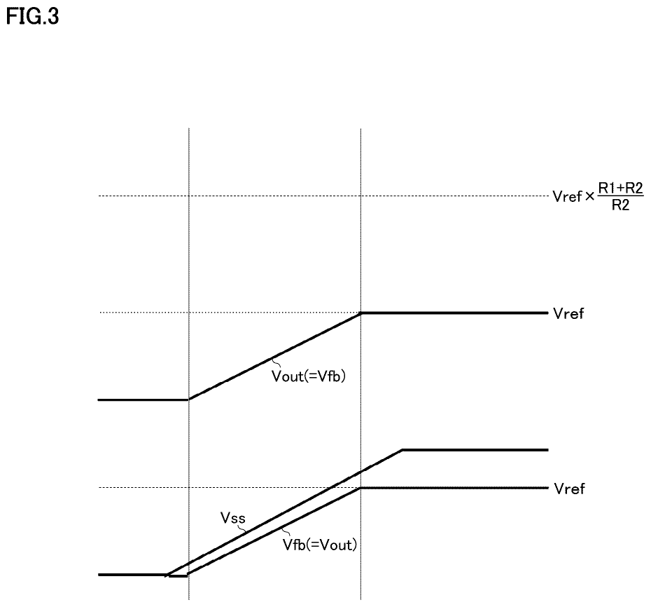

FIG. 3 shows the start-up waveform when the feedback terminal FB of the comparative example is abnormal (lower resistor open or upper resistor short). The lower resistor open can be understood as a state in which the first end of the resistor R2 is not correctly connected to the feedback terminal FB, or the second end of the resistor R2 is not correctly connected to the ground terminal, or both. The upper resistor short can be understood as a state in which both ends of the resistor R1 are short-circuited. The upper part of this figure shows the behavior of the output voltage Vout. The lower part of this figure shows the behavior of the soft-start voltage Vss and the feedback voltage Vfb.

As shown in this figure, when the lower resistor of the feedback terminal FB is open or the upper resistor is short-circuited, Vout=Vfb. Therefore, the output voltage Vout only rises to the reference voltage Vref. In other words, the output voltage Vout does not reach the desired target value (=Vref×(R1+R2)/R2). Therefore, there is a risk of causing a problem in the operation of the load that receives the output voltage Vout.

Conversely, however, the output voltage Vout does not exceed the target value. In other words, there is no risk of the output voltage Vout exceeding the withstand voltage of the load. Therefore, even if no special countermeasures are taken, the safety of the power supply device X and the load (and thus the entire system) is not compromised.

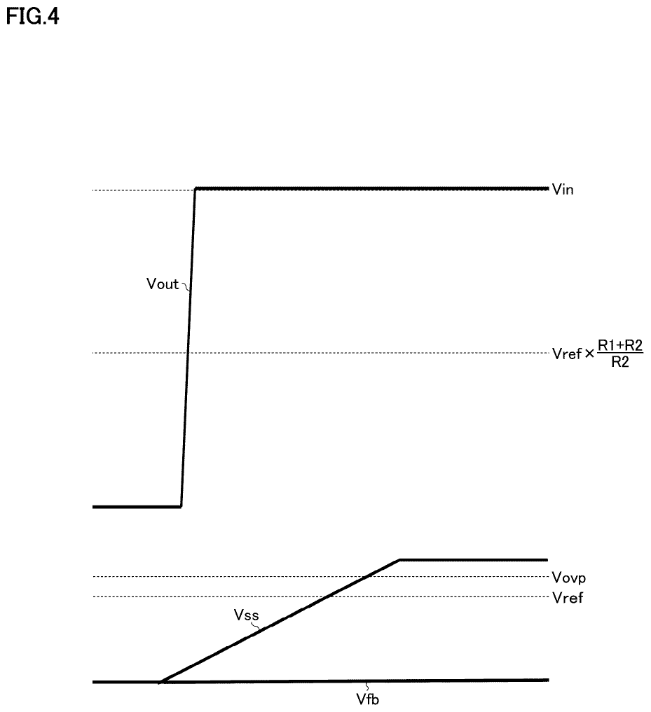

FIG. 4 shows the start-up waveform when the feedback terminal FB of the comparative example is abnormal (upper resistor open or lower resistor short). The upper resistor open can be understood as a state in which the first end of the resistor R1 is not correctly connected to a terminal to which the output voltage Vout is applied, or the second end of the resistor R1 is not correctly connected to the feedback terminal FB, or both. The lower resistor short can be understood as a state in which both ends of the resistor R2 are short-circuited. In particular, the lower resistor short can be understood as a ground fault state of the feedback terminal FB (a short-circuit state to the ground terminal or a low-potential terminal equivalent thereto). The upper part of this figure shows the behavior of the output voltage Vout. The lower part of this figure shows the behavior of the soft-start voltage Vss and the feedback voltage Vfb.

As shown in this figure, when the upper resistor of the feedback terminal FB is open or the lower resistor is short-circuited, the feedback voltage Vfb remains at a low level (ground voltage GND). Therefore, feedback control is applied so as to raise the output voltage Vout without limit. Also, since the feedback voltage Vfb does not exceed the overvoltage protection threshold Vovp, the switching drive of the output stage 12 continues. As a result, the output voltage Vout exceeds the desired target value (=Vref×(R1+R2)/R2) and rises to the input voltage Vin. In such a situation, the output voltage Vout may exceed the withstand voltage of the load.

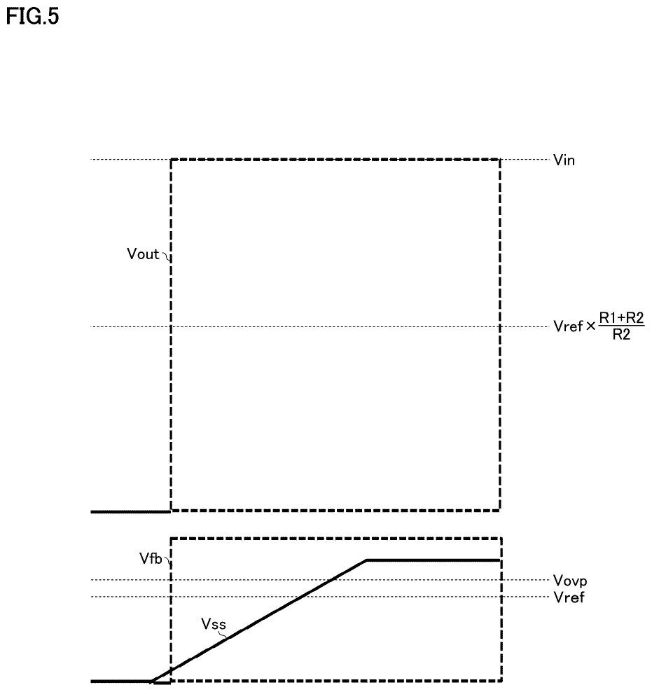

FIG. 5 is a diagram showing the start-up waveform when the feedback terminal FB of the comparative example is abnormal (upper and lower resistor open). Upper and lower resistor open can be understood as a state in which both the upper resistor and the lower resistor are open. The upper part of this figure shows the behavior of the output voltage Vout. The lower part of the figure shows the behavior of the soft-start voltage Vss and the feedback voltage Vfb.

As shown in the figure, when the upper and lower resistors of the feedback terminal FB are open, the feedback voltage Vfb becomes unstable (see the dashed frame of the feedback voltage Vfb). Therefore, the output voltage Vout also becomes unstable and may rise to the input voltage Vin beyond the desired target value (=Vref×(R1+R2)/R2) (see the dashed frame of the output voltage Vout). In such a situation, the output voltage Vout may exceed the withstand voltage of the load. In particular, in a situation where Vref<Vfb<Vovp, the output voltage Vout is maintained in a state where it exceeds the target value without overvoltage protection.

In the following, in consideration of the discussion above, a power supply device X is proposed that can prevent the output voltage Vout from rising (overvoltage) when the feedback terminal FB is abnormal.

### Power Supply Device (First Embodiment)

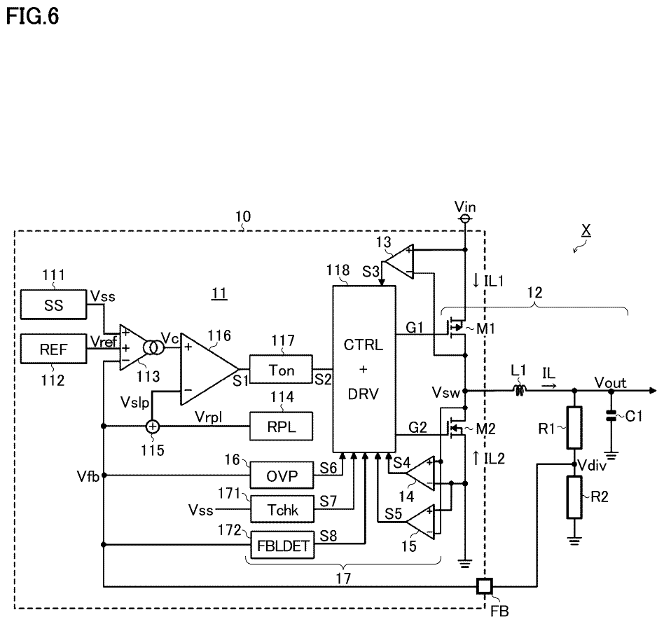

FIG. 6 is a diagram showing a first embodiment of the power supply device. The power supply device X of the present embodiment is based on the comparative example (FIG. 1) and further includes a terminal inspection circuit 17. In the first embodiment, as described in detail below, the occurrence of an overvoltage due to the upper resistor open or the lower resistor short at the feedback terminal FB can be prevented in advance.

The terminal inspection circuit 17 detects an abnormality in the feedback terminal FB when the power supply device X starts up and forcibly stops the switching drive of the output stage 12. In accordance with this figure, the terminal inspection circuit 17 includes a detection period setting circuit 171 and a lower limit detection circuit 172.

The terminal inspection circuit 17 can be understood as a functional block including not only the detection period setting circuit 171 and the lower limit detection circuit 172, but also the control drive circuit 118, the upper overcurrent protection circuit 13, and the lower overcurrent protection circuit 14.

The detection period setting circuit 171 generates a detection period setting signal S7 for setting an abnormality detection period Tchk of the feedback terminal FB. The control drive circuit 118, which functions as a part of the terminal inspection circuit 17, sets the abnormality detection period Tchk of the feedback terminal FB at the start-up of the power supply device X according to the detection period setting signal S7. The detection period setting signal S7 may be, for example, a binary signal whose logic level changes depending on the result of the comparison between the soft-start voltage Vss and the detection period completion threshold Vchk. A detection period completion threshold Vchk may be set to a reference voltage Vref or a voltage value lower than the reference voltage Vref. In this case, the control drive circuit 118 completes the abnormality detection period Tchk when the soft-start voltage Vss exceeds the detection period completion threshold Vchk.

The lower limit detection circuit 172 compares the feedback voltage Vfb with a predetermined lower limit detection threshold VfbL to generate a lower limit detection signal S8. The lower limit detection threshold VfbL may be set to a voltage value lower than the reference voltage Vref. The lower limit detection threshold VfbL may be set to a voltage value lower than the detection period completion threshold Vchk.

The control drive circuit 118 detects an abnormality in the feedback terminal FB based on the detection period setting signal S7, the lower limit detection signal S8, the upper overcurrent protection signal S3, and the lower overcurrent protection signal S4. For example, when the control drive circuit 118 detects that the feedback voltage Vfb is lower than the lower limit detection threshold VfbL within the abnormality detection period Tchk at the time of start-up and that the output current IL flowing through the output stage 12 is higher than the upper limit detection threshold (for example, the overcurrent protection threshold Iocp), the control drive circuit 118 forcibly stops the switching drive of the output stage 12.

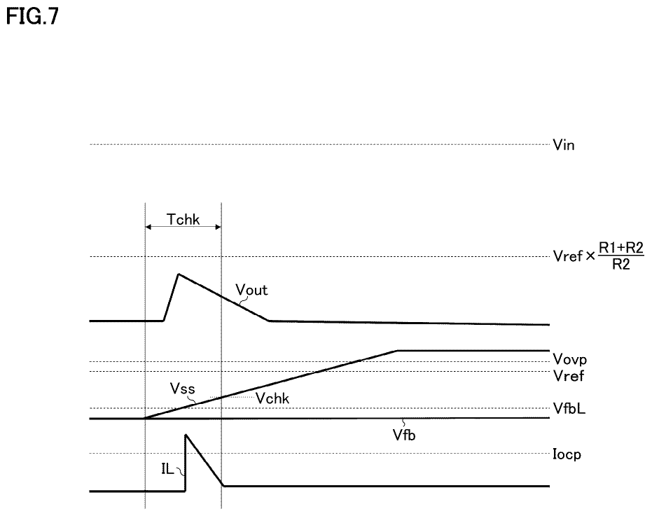

FIG. 7 is a diagram showing the start-up waveform when the feedback terminal FB of the first embodiment is abnormal (upper resistor open or lower resistor short). The upper part of this figure shows the behavior of the output voltage Vout. The middle part of the figure shows the behavior of the soft-start voltage Vss and the feedback voltage Vfb. The lower part of the figure shows the behavior of the output current IL.

As described in FIG. 4 above, when the upper resistor of the feedback terminal FB is open or the lower resistor is short-circuited, the feedback voltage Vfb remains at a low level (ground voltage GND). Therefore, feedback control is applied to keep raising the output voltage Vout. Furthermore, since the feedback voltage Vfb does not exceed the overvoltage protection threshold Vovp, the switching drive of the output stage 12 continues. Therefore, unless some countermeasures are taken, the output voltage Vout may exceed the target value (=Vref×(R1+R2)/R2) and rise to the input voltage Vin.

On the other hand, in the power supply device X of the present embodiment, when an abnormality in the feedback terminal FB is detected at start-up, the switching drive of the output stage 12 is forcibly stopped. In accordance with this figure, when it is detected that the feedback voltage Vfb is lower than the lower limit detection threshold VfbL during the abnormality detection period Tchk at start-up and the output current IL flowing through the output stage 12 is higher than the upper limit detection threshold (overcurrent protection threshold Iocp), the switching drive of the output stage 12 is forcibly stopped.

With such an abnormality protection operation of the feedback terminal FB, the switching drive of the output stage 12 is forcibly stopped before the output voltage Vout exceeds the target value (=Vref×(R1+R2)/R2). Therefore, the safety of the power supply device X and the load (and therefore the entire system) is improved.

As a modification of the above-described embodiment, the terminal inspection circuit 17 may forcibly stop the switching drive of the output stage 12 when it is detected that the feedback voltage Vfb is lower than the lower limit detection threshold VfbL at the completion of the abnormality detection period Tchk. In this case, the upper overcurrent protection circuit 13 and the lower overcurrent protection circuit 14 may be excluded from the components of the terminal inspection circuit 17.

### Power Supply Device (Second Embodiment)

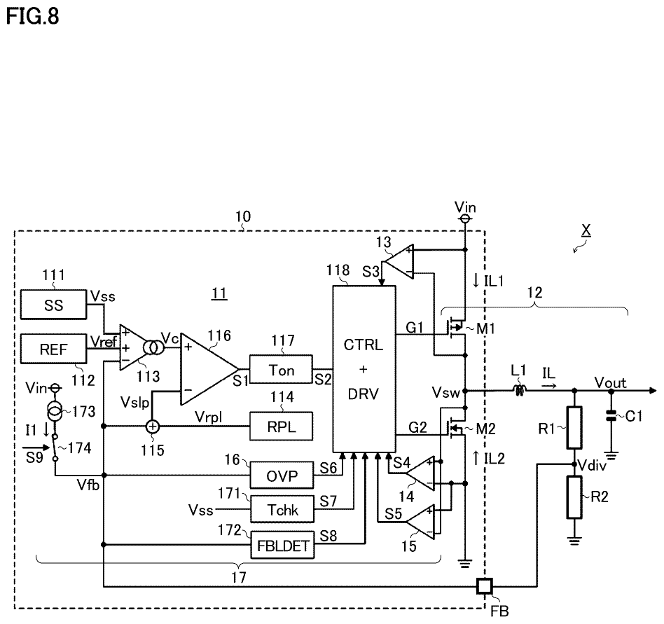

FIG. 8 is a diagram showing a second embodiment of the power supply device. The power supply device X of the present embodiment is based on the first embodiment (FIG. 6) described above, but components are added to the terminal inspection circuit 17. In accordance with this figure, the terminal inspection circuit 17 includes a current source 173 and a switch 174 in addition to the detection period setting circuit 171 and lower limit detection circuit 172 described above. Note that in the second embodiment, as described in detail below, not only the occurrence of an upper resistor open or a lower resistor short at the feedback terminal FB, but also the occurrence of an overvoltage caused by an upper and lower resistor open at the feedback terminal FB can be prevented.

The first end of the current source 173 is connected to a terminal to which the input voltage Vin is applied. The second end of the current source 173 is connected to the first end of the switch 174. The second end of the switch 174 is connected to the feedback terminal FB. The current source 173 generates a predetermined source current I1. The switch 174 is turned on/off according to a switching signal S9. For example, the switch 174 may be turned on during the current supply period Tcs set at the start-up of the power supply device X, and turned off during the remaining period.

In this way, the terminal inspection circuit 17 passes the source current I1 from a node having a higher potential than the overvoltage protection threshold Vovp (the application terminal of the input voltage Vin in this figure) to the feedback terminal FB during the current supply period Tcs at the start-up. The technical significance of this will be described in detail below.

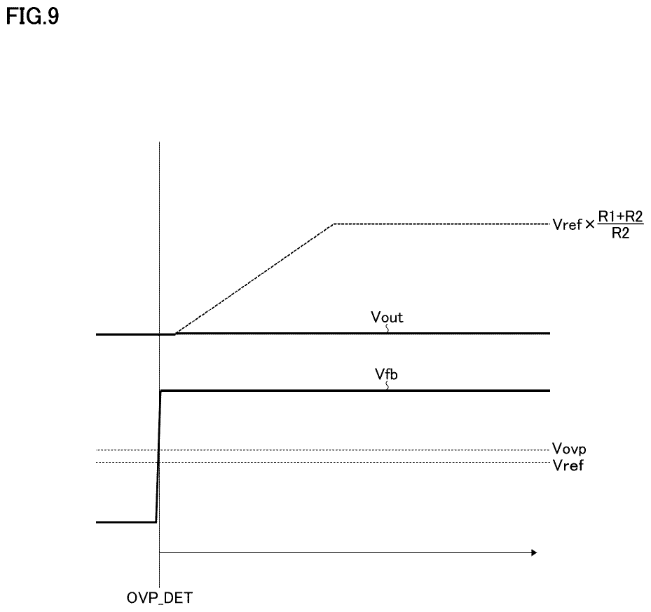

FIG. 9 is a diagram showing the start-up waveform when the feedback terminal FB of the second embodiment is abnormal (upper and lower resistor open). The upper part of this figure shows the behavior of the output voltage Vout. The lower part of this figure shows the behavior of the feedback voltage Vfb.

As described in FIG. 5 above, when the upper and lower resistors of the feedback terminal FB are open, the feedback voltage Vfb becomes unstable. Therefore, the output voltage Vout also becomes unstable. Therefore, unless some countermeasures are taken, the output voltage Vout may exceed the desired target value (=Vref×(R1+R2)/R2) and rise to the input voltage Vin.

On the other hand, in the power supply device X of the present embodiment, the source current I1 is flowed into the feedback terminal FB in an open state throughout the current supply period Tcs at the time of start-up. Therefore, immediately after the power supply device X starts up, the feedback voltage Vfb rises until it exceeds the overvoltage protection threshold Vovp. As a result, the existing overvoltage protection function forcibly stops the switching drive of the output stage 12. In other words, when the feedback terminal FB is open, the output voltage Vout does not rise even when the power supply device X starts up (see the solid and dashed lines in the upper row).

By such an abnormality protection operation of the feedback terminal FB, the switching drive of the output stage 12 is forcibly stopped before the output voltage Vout exceeds the target value (=Vref×(R1+R2)/R2). Therefore, the safety of the power supply device X and the load (and therefore the entire system) is improved.

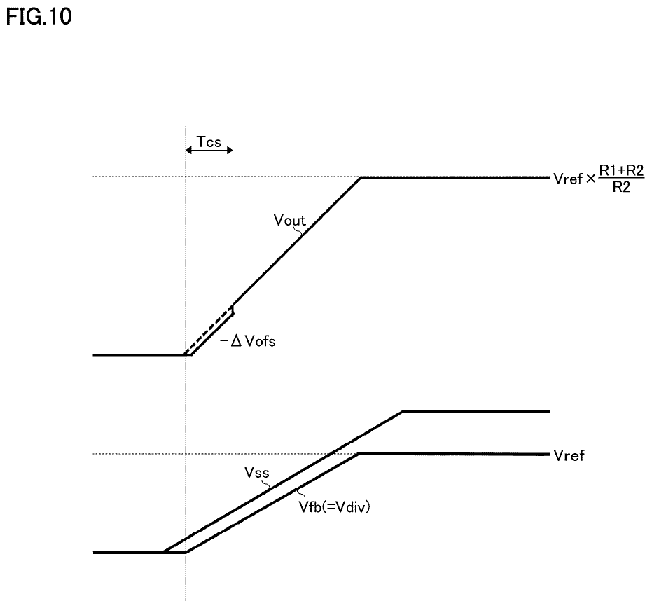

FIG. 10 is a diagram showing the start-up waveform when the feedback terminal FB of the second embodiment is normal. The upper part of this figure shows the behavior of the output voltage Vout. The lower part of this figure shows the behavior of the soft-start voltage Vss and the feedback voltage Vfb.

When the feedback terminal FB is normal, the source current I1 is added to the current flowing through the resistor R2 in the current supply period Tcs mentioned above. Therefore, as shown in this figure, a negative offset component −ΔVofs caused by the increase in the voltage across the resistor R2 is applied to the output voltage Vout. However, the source current I1 is stopped after the current supply period Tcs is completed. Therefore, the offset component −ΔVofs is not added to the output voltage Vout after the start-up. For example, if the current supply period Tcs is set to be completed before the soft-start voltage Vss exceeds the reference voltage Vref, there is no particular problem with the steady operation of the power supply device X.

In addition, if care for the upper resistor open or the lower resistor short at the feedback terminal FB is ignored, the detection period setting circuit 171 and the lower limit detection circuit 172 described above may be omitted.

### Power Supply Device (Third Embodiment)

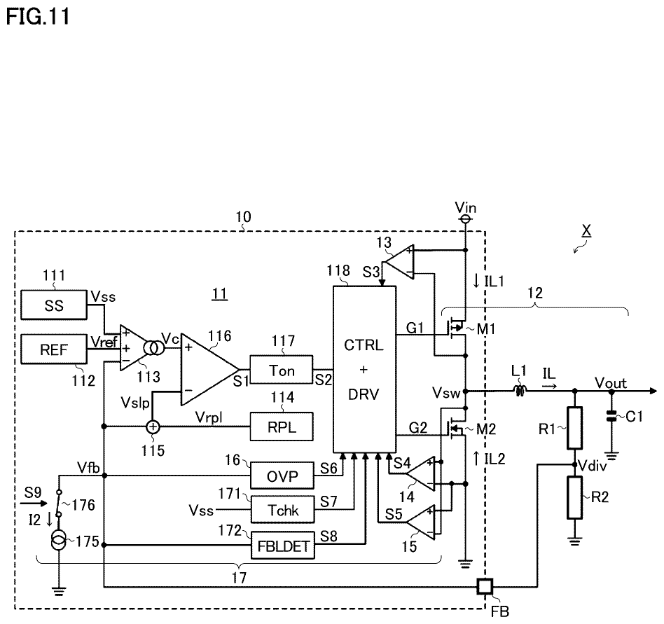

FIG. 11 is a diagram showing a third embodiment of the power supply device. The power supply device X of the present embodiment is based on the first embodiment (FIG. 6) above, but the components of the terminal inspection circuit 17 are changed. In accordance with this figure, the terminal inspection circuit 17 includes a current source 175 and a switch 176 instead of the current source 173 and switch 174 described above. In the third embodiment, as described in detail below, not only the upper resistor open or the lower resistor short at the feedback terminal FB, but also an overvoltage caused by the upper and lower resistor open at the feedback terminal FB can be prevented.

The first end of the current source 175 is connected to the ground terminal. The second end of the current source 175 is connected to the first end of the switch 176. The second end of the switch 176 is connected to the feedback terminal FB. The current source 175 generates a predetermined sink current I2. The switch 176 is turned on/off according to a switching signal S9. For example, the switch 176 may be turned on during the current supply period Tcs set at the time of start-up of the power supply device X, and turned off during the remaining period.

In this way, the terminal inspection circuit 17 passes the sink current I2 from the feedback terminal FB to a node (the ground terminal in this figure) at a lower potential than the lower limit detection threshold VfbL during the current supply period Tcs at the time of start-up. The technical significance of this will be described in detail below.

As described in FIG. 5 above, when the upper and lower resistors of the feedback terminal FB are open, the feedback voltage Vfb becomes unstable. Therefore, the output voltage Vout also becomes unstable. Therefore, unless some countermeasures are taken, the output voltage Vout may exceed the desired target value (=Vref×(R1+R2)/R2) and rise to the input voltage Vin.

On the other hand, in the power supply device X of the third embodiment, the sink current I2 is drawn from the feedback terminal FB in an open state throughout the current supply period Tcs at start-up. Therefore, the feedback voltage Vfb remains at a low level (ground voltage GND). Therefore, the start-up waveform when the feedback terminal FB is abnormal (upper and lower resistors are open) is the same as that in FIG. 7 above.

For example, the current supply period Tcs may coincide with the abnormality detection period Tchk, or may be included in the abnormality detection period Tchk. With such a setting, it is detected that the feedback voltage Vfb is lower than the lower limit detection threshold VfbL and the output current IL flowing through the output stage 12 is higher than the upper limit detection threshold (overcurrent protection threshold Iocp) within the abnormality detection period Tchk at start-up. As a result, the switching drive of the output stage 12 is forcibly stopped.

With such an abnormality protection operation of the feedback terminal FB, the switching drive of the output stage 12 is forcibly stopped before the output voltage Vout exceeds the target value (=Vref×(R1+R2)/R2). Therefore, the safety of the power supply device X and the load (and therefore the entire system) is improved.

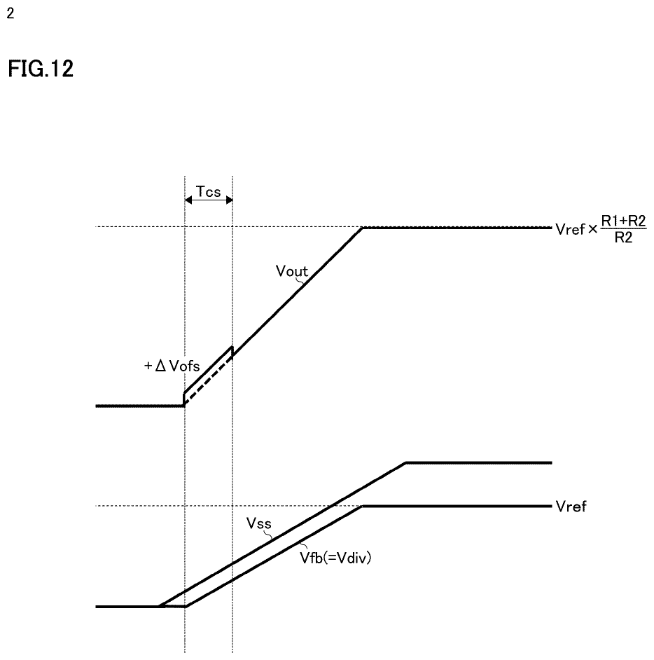

FIG. 12 is a diagram showing the start-up waveform when the feedback terminal FB of the third embodiment is normal. The upper part of this figure shows the behavior of the output voltage Vout. The lower part of the figure shows the behavior of the soft-start voltage Vss and the feedback voltage Vfb.

When the feedback terminal FB is normal, the sink current I2 is subtracted from the current flowing through the resistor R2 in the current supply period Tcs. Therefore, as shown in the figure, a positive offset component +ΔVofs caused by the voltage drop across the resistor R2 is applied to the output voltage Vout. However, the sink current I2 is stopped after the current supply period Tcs is completed. Therefore, the offset component +ΔVofs is not applied to the output voltage Vout after start-up. For example, if the current supply period Tcs is set to be completed before the soft-start voltage Vss exceeds the reference voltage Vref, there is no particular problem with the steady operation of the power supply device X.

### Power Supply Device (Fourth Embodiment)

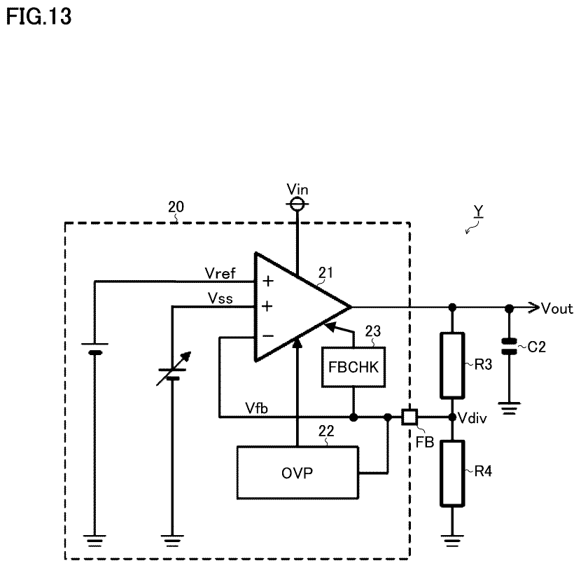

FIG. 13 is a diagram showing a fourth embodiment of the power supply device. The power supply device Y of the present embodiment is a step-down linear power supply (for example, a low drop-out (LDO) regulator) that steps down an input voltage Vin to generate a desired output voltage Vout. In accordance with this figure, the power supply device Y includes a power supply control device 20 and various discrete components (capacitor C2 and resistors R3 and R4) that are externally attached thereto.

The power supply control device 20 is a semiconductor integrated circuit device (a so-called power supply control IC) that centrally controls the operation of the power supply device Y. The power supply control device 20 includes a plurality of external terminals (only the feedback terminal FB is illustrated in this figure) as a means for establishing an electrical connection with the outside of the device.

Next, the external connection of the power supply control device 20 will be described. The first terminals of the resistor R3 and the capacitor C2 are both connected to the terminal to which the output voltage Vout is applied. The second terminal of the resistor R3 and the first terminal of the resistor R4 are both connected to the feedback terminal FB. The second terminals of the capacitor C2 and the resistor R4 are both connected to the ground terminal.

The resistors R3 and R4 function as a resistive voltage divider circuit that generates a divided voltage Vdiv (=Vout×R4/(R3+R4)) according to the output voltage Vout and outputs the divided voltage to the feedback terminal FB. Although not shown in the figure, a speed-up capacitor may be connected in parallel across the resistor R3 so that the power supply device Y starts up smoothly.

### Power Supply Control Device (Fourth Embodiment)

Next, with reference to FIG. 13, the internal configuration and operation of the power supply control device 20 will be described in detail. In the power supply control device 20 of the present embodiment, a feedback control circuit 21, an overvoltage protection circuit 22, and a terminal inspection circuit 23 are integrated.

The feedback control circuit 21 controls the linear output stage so that the feedback voltage Vfb applied to the feedback terminal FB matches the lower voltage of the soft-start voltage Vss and the reference voltage Vref. Therefore, when the resistors R3 and R4 are correctly connected externally to the feedback terminal FB, Vout=Vref×(R3+R4)/R4 is established. That is, the output voltage Vout can be arbitrarily adjusted according to the resistance ratio of the resistors R3 and R4 (corresponding to the voltage division ratio of the resistive voltage divider circuit).

The feedback control circuit 21 may incorporate an output transistor connected between the application terminal of the input voltage Vin and the application terminal of the output voltage Vout as a linear output stage.

The overvoltage protection circuit 22 forcibly stops the linear drive of the feedback control circuit 21 (particularly the output stage) when the feedback voltage Vfb exceeds a predetermined overvoltage protection threshold Vovp.

The terminal inspection circuit 23 detects an abnormality in the feedback terminal FB when the power supply device Y starts up and forcibly stops the linear drive of the feedback control circuit 21 (particularly the output stage). The configuration and operation of the terminal inspection circuit 23 may be arbitrarily applied to the first to third embodiments (FIGS. 6, 8, and 11). Therefore, duplicated explanations are omitted.

### Supplementary Notes

The features related to the above-described disclosure will be additionally noted.

For example, a power supply control device according to the present disclosure has a configuration (first configuration) that includes: a feedback terminal; a feedback control circuit configured to control an output stage of a power supply device according to a feedback voltage applied to the feedback terminal; and a terminal inspection circuit configured to forcibly stop driving the output stage when it is detected that the feedback voltage is lower than a first threshold and an output current flowing through the output stage is higher than a second threshold during a first period at start-up, or when it is detected that the feedback voltage is lower than the first threshold at completion of the first period.

The power supply control device according to the first configuration may have a configuration (second configuration) that further includes an overvoltage protection circuit configured to forcibly stop driving the output stage when the feedback voltage exceeds an overvoltage protection threshold.

The power supply control device according to the second configuration may have a configuration (third configuration) in which the terminal inspection circuit is configured to pass a source current from a node having a higher potential than the overvoltage protection threshold to the feedback terminal over a second period at start-up.

The power supply control device according to the first or second configuration may have a configuration (fourth configuration) in which the terminal inspection circuit is configured to pass a sink current from the feedback terminal to a node having a lower potential than the first threshold during a second period at start-up.

The power supply control device according to any one of the first to fourth configurations may have a configuration (fifth configuration) in which the feedback control circuit is configured to control the output stage so that the feedback voltage matches a lower voltage of a soft-start voltage that rises at a predetermined slope at start-up and a predetermined reference voltage.

The power supply control device according to the fifth configuration may have a configuration (sixth configuration) in which the terminal inspection circuit is configured to complete the first period when the soft-start voltage exceeds the reference voltage or a third threshold lower than the reference voltage.

The power supply control device according to any one of the first to sixth configurations may have a configuration (seventh configuration) that further includes an overcurrent protection circuit configured to limit the output current to an overcurrent protection threshold or less, in which the terminal inspection circuit is configured to set the overcurrent protection threshold to the second threshold.

For example, a power supply control device according to the present disclosure may have a configuration (eighth configuration) that includes: a feedback terminal; a feedback control circuit configured to control an output stage of a power supply device according to a feedback voltage applied to the feedback terminal; an overvoltage protection circuit configured to forcibly stop driving the output stage when the feedback voltage exceeds an overvoltage protection threshold; and a terminal inspection circuit configured to pass a source current from a node having a higher potential than the overvoltage protection threshold to the feedback terminal for a predetermined period at start-up.

For example, a power supply device according to the present disclosure may have a configuration (ninth configuration) that includes: the power supply control device according to any one of the first to eighth configurations; the output stage configured to be controlled by the power supply control device to generate an output voltage from an input voltage; and a resistive voltage divider circuit configured to generate a divided voltage of the output voltage and output the divided voltage to the feedback terminal.

The power supply device according to the ninth configuration may have a configuration (tenth configuration) in which the output stage is of a switching type or a linear type.

According to the present disclosure, an increase in the output voltage can be prevented when an abnormality occurs in the feedback terminal.

### OTHERS

In addition to the above-described embodiments, various technical features disclosed in this specification can be modified in various ways without departing from the spirit of the technical ingenuity involved. In other words, the embodiments described above should be understood to be in every aspect illustrative and not restrictive. The technical scope of the present disclosure is defined not by the description of the embodiments given above but by the appended claims, and should be understood to encompass any modifications made in a sense and scope equivalent to those of the claims.

What is claimed is:

1. A power supply control device comprising:
a feedback terminal;
a feedback control circuit configured to control an output stage of a power supply device according to a feedback voltage applied to the feedback terminal; and
a terminal inspection circuit configured to forcibly stop driving the output stage when it is detected that the feedback voltage is lower than a first threshold and an output current flowing through the output stage is higher than a second threshold during a first period at start-up, or when it is detected that the feedback voltage is lower than the first threshold at completion of the first period.

2. The power supply control device according to claim 1, further comprising:
an overvoltage protection circuit configured to forcibly stop driving the output stage when the feedback voltage exceeds an overvoltage protection threshold.

3. The power supply control device according to claim 2, wherein
the terminal inspection circuit is configured to pass a source current from a node having a higher potential than the overvoltage protection threshold to the feedback terminal over a second period at start-up.

4. The power supply control device according to claim 1, wherein
the terminal inspection circuit is configured to pass a sink current from the feedback terminal to a node having a lower potential than the first threshold during a second period at start-up.

5. The power supply control device according to claim 1, wherein
the feedback control circuit is configured to control the output stage so that the feedback voltage matches a lower voltage of a soft-start voltage that rises at a predetermined slope at start-up and a predetermined reference voltage.

6. The power supply control device according to claim 5, wherein
the terminal inspection circuit is configured to complete the first period when the soft-start voltage exceeds the reference voltage or a third threshold lower than the reference voltage.

7. The power supply control device according to claim 1, further comprising:
an overcurrent protection circuit configured to limit the output current to an overcurrent protection threshold or less, wherein
the terminal inspection circuit is configured to set the overcurrent protection threshold to the second threshold.

8. A power supply control device comprising:
a feedback terminal;
a feedback control circuit configured to control an output stage of a power supply device according to a feedback voltage applied to the feedback terminal;
an overvoltage protection circuit configured to forcibly stop driving the output stage when the feedback voltage exceeds an overvoltage protection threshold; and
a terminal inspection circuit configured to pass a source current from a node having a higher potential than the overvoltage protection threshold to the feedback terminal for a predetermined period at start-up.

9. A power supply device comprising:
the power supply control device according to claim 1;
the output stage configured to be controlled by the power supply control device to generate an output voltage from an input voltage; and
a resistive voltage divider circuit configured to generate a divided voltage of the output voltage and output the divided voltage to the feedback terminal.

10. The power supply according to claim 9, wherein
the output stage is of a switching type or a linear type.

11. A power supply comprising:
the power supply control device according to claim 8;
the output stage configured to be controlled by the power supply control device to generate an output voltage from an input voltage; and
a resistive voltage divider circuit configured to generate a divided voltage of the output voltage and output the divided voltage to the feedback terminal.

12. The power supply according to claim 11, wherein
the output stage is of a switching type or a linear type.
